(19) United States
(12) Patent Application Publication
(10) Pub. No.: US 2026/0224438 A1
(43) Pub. Date: Aug. 6, 2026

(54) COMPRESSION GARMENTS AND METHODS OF MANUFACTURE

(71) Applicant: QoLIFY LLC, New York, NY (US)

(72) Inventor: Isabelle Brock, Chicago, IL (US)

(73) Assignee: QoLIFY LLC, New York, NY (US)

(21) Appl. No.: 19/154,319

(22) PCT Filed: Feb. 7, 2024
(86) PCT No.: PCT/US2024/014776

§ 371 Date: Aug. 6, 2025

Related U.S. Application Data
(60) Provisional application No. 63/443,772, filed on Feb. 7, 2023.

(51) Int. Cl. A61H 39/04; A41D 13/12; A41D 27/20; A61H 39/00

(52) U.S. Cl. CPC A61H 39/04; A41D 13/1245; A41D 13/1254; A41D 27/20; A61H 39/002; A41D 2300/322; A41D 2400/324

(57) ABSTRACT

A proprioception garment configured to enable a selective reduction in a compression load along certain edges of the proprioception garment, the proprioception garment including a plurality of fabric panels stitched together to form a proprioception garment configured to apply a compressive load of between about 6 mmHg and about 15 mmHg to a user wearing the proprioception garment, the proprioception garment including at least one cuff assembly positioned along one edge of the proprioception garment, the at least one cuff assembly including an adjustable fastener mechanism selectively adjustable between a maximum compression load of between about 6 mmHg and about 15 mmHg and a minimum compression load of about 0 mmHg.

### CROSS-REFERENCE TO RELATED APPLICATIONS

This application is being filed on Feb. 7, 2024, as a PCT International application and claims the benefit of and priority to U.S. Provisional Patent Application No. 63/443,772, filed Feb. 7, 2023, and titled “COMPRESSION GARMENTS AND METHODS OF MANUFACTURE” the disclosure of which is hereby incorporated by reference in its entirety.

### TECHNICAL FIELD

The present disclosure relates generally to compression garments and methods of manufacture, and more particularly to garments that improve proprioception, the unconscious perception of movement and spatial orientation arising from stimuli within the body.

### BACKGROUND

Proprioception, occasionally referred to as kenaesthesia, is the sense of self movement, force and body position. Proprioception is mediated by proprioceptors, mechanosensory neurons located within muscles, tendons, and joints. The proprioceptors detect distinct kinematic parameters, such as joint position, movement, and load. The proprioceptive signals are transmitted to the central nervous system, where they are integrated with information from other sensory systems, such as the visual system and the vestibular system, to create an overall representation of body position, movement, and acceleration. Sensory feedback from proprioceptors is considered essential for stabilizing body posture and coordinating body movement.

Some people have medical conditions in which their proprioception is reduced or distorted. For example, many people with Ehlers-Danlos Syndrome (EDS) experience impaired proprioception. This syndrome is a connective tissue disorder in which the tissues are on average more elastic in comparison to the general population. As a result of this disorder, proprioception information received by the central nervous system can be distorted, causing impaired sensations.

It has been found that proprioception can be improved by compressing the tissues to reduce the stretching of the tissues back to their proper proportions. In doing so the nerves receive the correct information (or less distorted information) and proprioception is improved or restored. One way to provide the compression is through a garment.

### SUMMARY OF THE DISCLOSURE

Embodiments described herein can provide a proprioception garment designed to offer targeted pressure and stimulation therapy at specific acupressure points on the wearer's body, and may incorporate various aspects as disclosed herein in any combination. In one aspect, the garment is engineered to exert a compressive load ranging between approximately 6 mmHg and 15 mmHg, optimizing therapeutic pressure application. In one aspect, the incorporation of acupressure nodes or stimulators on the garment's interior surface allows for precise acupressure therapy at locations specified by the user, enhancing personalized treatment effectiveness.

In one aspect, a visual indicator is strategically positioned on the garment to denote the exact acupressure points, facilitating the correct placement of the acupressure nodes or stimulators. In one aspect, the material of the visual indicator is selected for its non-elastic quality compared to the surrounding fabric, thereby increasing the compressive force at the indicated point and intensifying the acupressure effect. In one aspect, each acupressure node or stimulator features a securement mechanism to ensure it remains in the desired position, providing consistent therapeutic pressure.

In one aspect, the garment includes one or more pockets specifically designed to house the acupressure nodes or stimulators, allowing for easy customization and adjustment by the wearer. In one aspect, the garment is equipped with cuff assemblies that feature tabs for easy adjustment and securement around the wearer's ankles or wrists, enhancing the garment's fit and comfort. In one aspect, these cuff assemblies incorporate a hook and loop fastener system, with the tabs enabling the wearer to adjust the compressive force exerted by the cuff, offering a range from therapeutic compression to a relaxed fit as needed.

Embodiments described herein can provide a proprioception garment designed for customizable pressure application and acupressure therapy, and may incorporate various aspects as disclosed herein in any combination. In one aspect, the garment features adjustable cuff assemblies along certain edges, enabling users to selectively reduce the compression load to accommodate personal comfort and therapeutic needs. In one aspect, these cuff assemblies include tabs that extend from their circumference, specifically designed to encircle a user's ankle or wrist, facilitating easy adjustment and securement. In one aspect, the incorporation of a hook and loop fastener mechanism within the cuff assemblies enhances the adjustability and security of the garment's fit, allowing users to modify the compressive force exerted by the cuff assembly. This adjustability ranges from a therapeutic compression load of approximately 6 mmHg to 15 mmHg down to a relaxed fit at approximately 0 mmHg. In one aspect, a visual indicator is strategically positioned on the garment to denote user-specified locations for acupressure points, aiding in the accurate placement of acupressure nodes or stimulators.

In one aspect, the material of the visual indicator is chosen for its non-elastic quality compared to the surrounding fabric, thereby increasing the compressive force at the indicated point and enhancing the effectiveness of acupressure therapy. In one aspect, the garment is equipped with a securement mechanism for the acupressure nodes or stimulators, ensuring their stable positioning against the interior surface of the garment for consistent therapeutic pressure. In one aspect, the garment includes integrated pockets designed to accommodate and securely hold the acupressure nodes or stimulators, allowing for user customization and ease of adjustment.

Embodiments described herein can provide a comprehensive computer system designed to customize and refine the fit of proprioception garments using advanced artificial intelligence algorithms, and may incorporate various aspects as disclosed herein in any combination. In one aspect, the system is equipped to collect precise body measurements from users to ensure a tailored fit. In one aspect, an AI algorithm, structured as a neural network with multiple layers, inputs these measurements to calculate the exact dimensions needed for the fabric panels of the proprioception garment.

In one aspect, the system generates initial dimensions for the fabric panels, which can be assembled into an initial version of the proprioception garment. Following this, in one aspect, the system presents users with a survey to evaluate the fit of this initial garment, enabling the collection of valuable user feedback. In one aspect, based on the feedback received, user measurements are revised and re-inputted into the AI algorithm to refine the garment's fit further.

In one aspect, the AI algorithm's bias and weight values are dynamically adjusted according to user feedback, enhancing the precision of the garment measurements generated. In one aspect, the system provides visualizations of the proprioception garment based on this feedback, allowing users to assess the fit visually before the construction of a subsequent version of the garment.

In one aspect, a feedback loop mechanism is implemented, enabling multiple iterations of feedback collection, measurement revision, and garment dimension generation until a user-defined threshold of fit satisfaction is reached. In one aspect, a user interface is provided for users to input specific fit preferences and desired garment characteristics, further personalizing the garment design process.

In one aspect, the fit of the proprioception garment is analyzed using virtual simulation, allowing the AI algorithm to adjust garment dimensions in a virtual environment to anticipate and correct potential fit issues before the physical garment is produced. In one aspect, the system allows users to select from a range of predefined garment adjustments after providing feedback, with each selection corresponding to specific alterations in the AI algorithm's bias and weight values, facilitating a highly personalized garment fitting experience.

The summary above is not intended to describe each illustrated embodiment or every implementation of the present disclosure. The figures and the detailed description that follow more particularly exemplify these embodiments.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a front perspective view depicting a proprioception government, in accordance with an embodiment of the disclosure.

FIG. 2 is a left side perspective view depicting the proprioception garment of FIG. 1, in accordance with an embodiment of the disclosure.

FIG. 3 is a rear perspective view depicting the proprioception garment of FIG. 2, in accordance with an embodiment of the disclosure.

FIG. 4 is an anatomical diagram depicting example top portion measurements, in accordance with an embodiment of the disclosure.

FIG. 5 is an anatomical diagram depicting example bottom portion measurements, in accordance with an embodiment of the disclosure.

FIG. 6 is a schematic view depicting an example computer system for customizing and refining the fit of a proprioception garment, in accordance with an embodiment of the disclosure.

FIG. 7A is a schematic view depicting an example algorithm configured to translate measurements of a user into fabric panel dimensions for the construction of a proprioception garment specifically tailored to an individual user, in accordance with an embodiment of the disclosure.

FIG. 7B is a schematic view depicting a single neuron of the algorithm of FIG. 6, in accordance with an embodiment of the disclosure.

FIG. 8 is a flowchart depicting a method of training and using the algorithm of FIG. 7A, in accordance with an embodiment of the disclosure.

FIGS. 9-12 are various views depicting the fabric panels making up a top portion of a proprioception garment, in accordance with an embodiment of the disclosure.

FIGS. 13-15 are various views depicting the fabric panels making up a bottom portion of a proprioception garment, in accordance with an embodiment of the disclosure.

FIG. 16 is a schematic view depicting applied compression loads of the various fabric panels making up a proprioception garment, in accordance with an embodiment of the disclosure.

FIG. 17 is a close-up view depicting a stitch seam between fabric panels of a proprioception garment, in accordance with an embodiment of the disclosure.

FIGS. 18-19 are perspective views depicting a top portion of a proprioception garment including tabs configured to operably coupled to a bottom portion of a proprioception garment.

FIGS. 20-21 are perspective views depicting a zipper assembly of a top portion of a proprioception garment, in accordance with an embodiment of the disclosure.

FIG. 22 is a perspective view of an adjustable cuff assembly of a proprioception garment, in accordance with an embodiment of the disclosure.

FIG. 23 is an anatomical diagram depicting various acupressure points on the body of a human.

FIG. 24 is a schematic diagram depicting an acupressure node and electronic stimulator configured to be received within a pocket defined by proprioception garment, in accordance with an embodiment of the disclosure.

### DETAILED DESCRIPTION

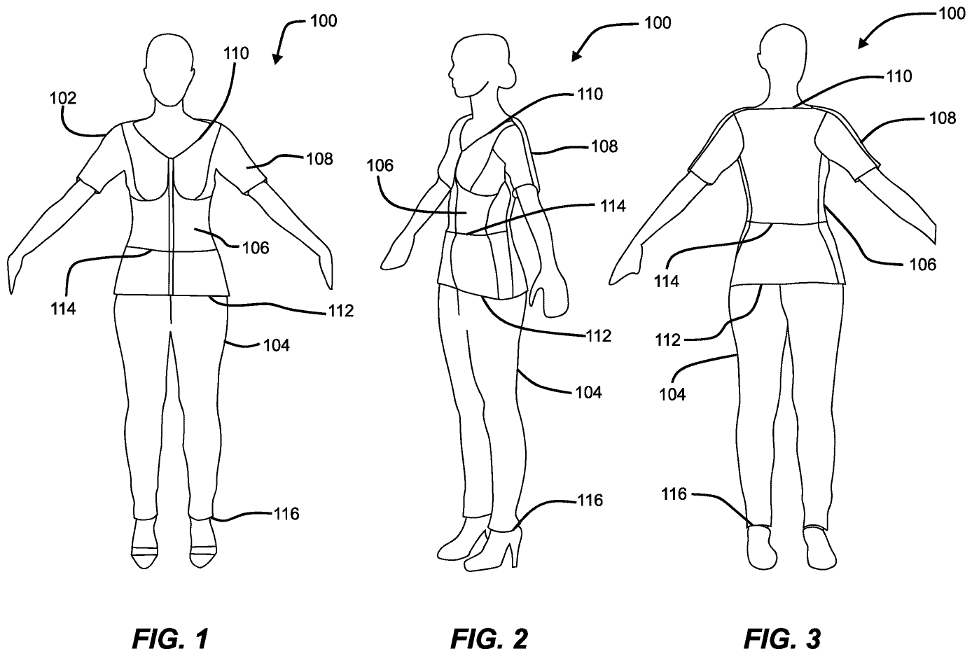

Referring to FIGS. 1-3, a proprioception garment 100 tuned to provide compression for improved proprioception is depicted in accordance with an embodiment of the disclosure. In embodiments, the proprioception garment 100 can include a the top portion 102, alternatively referred to as a shirt, an upper portion or a tunic, and a bottom portion 104, alternatively referred to as a lower portion, pants, or trousers. In embodiments, the top portion 102 and the bottom portion 104 can be tailor-made specific to the measurements of an individual, so as to be uniquely tuned to a specific body type/shape to provide a desired amount or degree of compression for improved proprioception, while not so much compression or pressure as to cause an allergic reaction (e.g., mast cell activation, or the like). Accordingly, methods for constructing the proprioception garment 100, as described in detail herein, enable the top portion 102 and the bottom portion 104 to be custom-fit for a specific user.

In embodiments, the top portion 102 can be configured as a full zip shirt, having a zipper 106 positioned along the front of the top portion 102. Although the top portion 102 is depicted as including short sleeves 108, embodiments of the present disclosure can alternatively include quarter length or long sleeves. Further, although the top portion 102 is depicted as having a v-neck neckline 110, embodiments of the present disclosure may alternatively include a crewneck, turtleneck, u-neck, square neck, and boat neckline configuration. In some embodiments, a bottom edge 112 of the shirt can extend below a waist line of the user to overlap with the portion of the bottom portion 104 of the proprioception garment 100, thereby providing improved support for the hips of the user. Additionally, in some embodiments, the top portion 102 may be comprised of several panels stitched together to create a more conforming top portion 102 with improved compression.

The bottom portion 104 can be configured as a pair of compression leggings, and can be generally free from rigid fasteners (e.g., zippers, buttons or the like), thereby providing a more uniform compression over the lower portion (e.g., legs, etc.) of the user. The bottom portion 104 can include a waistline 114, which can be positioned beneath at least a portion of the top portion 102 during use, and a hemline 116 positioned in proximity to an ankle of the user. Accordingly, in embodiments, the bottom portion 104 can be represented as full length trousers; alternatively the bottom portion can be constructed in a quarter length or short format. Additionally, in some embodiments, the bottom portion 104 may be comprised of several panels stitched together to create a more conforming bottom portion 104 with improved compression.

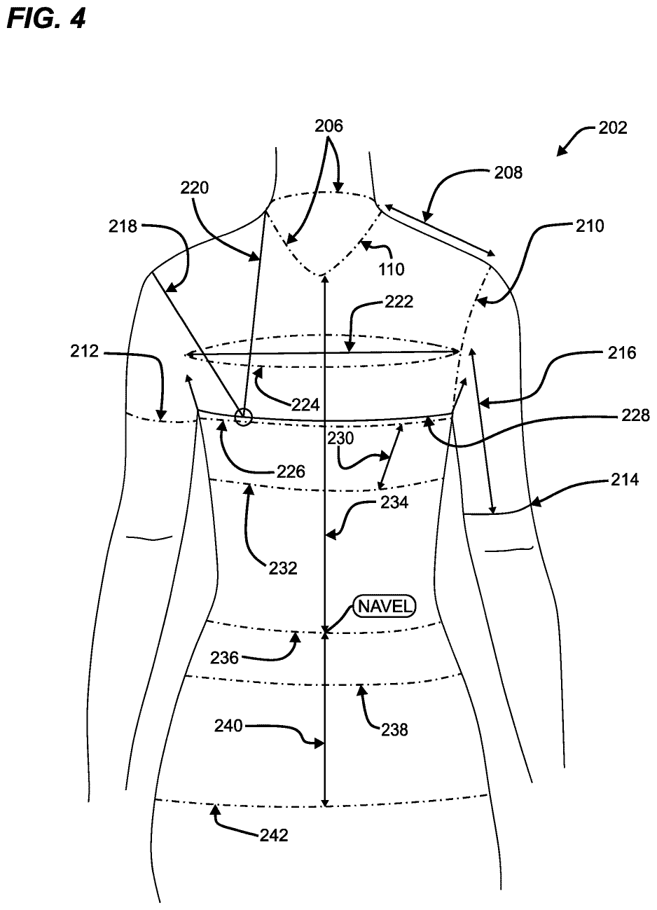

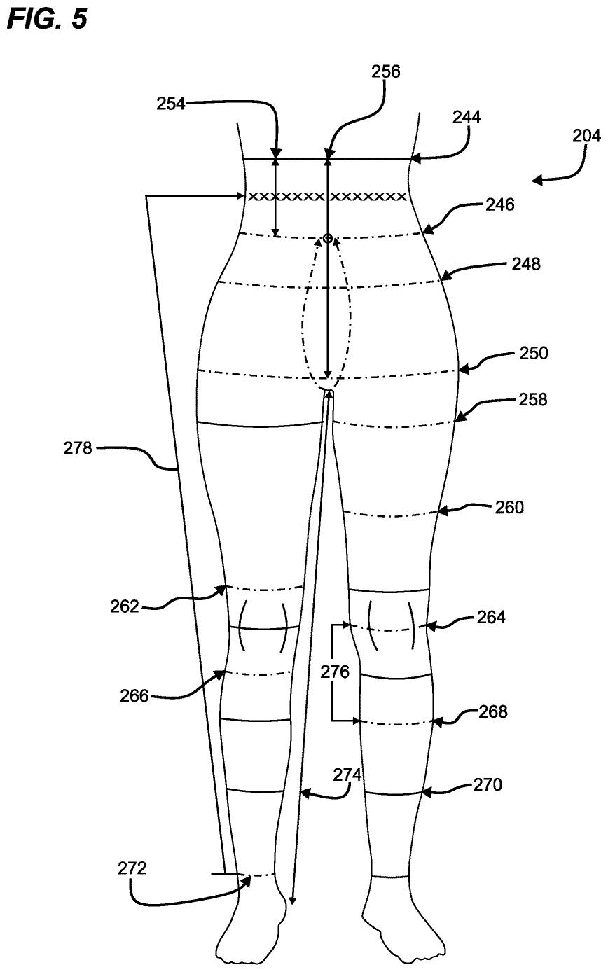

With additional reference to FIGS. 4 and 5, user measurements for tuning the proprioception garment 100 are provided in accordance with an embodiment of the disclosure. In particular, FIG. 4 depicts an example set of top portion measurements 202 for appropriate sizing and compression of the top portion 102, while FIG. 5 depicts an example set of bottom portion measurements 204 for appropriate sizing and compression of the bottom portion 104. As depicted, the solid lines can generally represent a dimension between two anatomical points, while the dashed or broken lines can represent a circumferential dimension around a perimeter of a portion of the user, having a beginning and ending at the same anatomical point.

In embodiments, the top portion measurements 202 can be represented as a plurality of anatomical measurements between or around certain features of the user. For example, a first measurement 206 can be represented as a circumference around a neck or collar area of a user to define the neck line 110. A second measurement 108 can represent a linear distance from the neckline 110 to a shoulder of a user to define a shoulder length of the user. A third measurement 210 can represent a circumference around a shoulder of the user. A fourth measurement 212 can represent a circumference around a bicep of the user. A fifth measurement 214 can represent a circumference around an end of the sleeve 108 of the user. A sixth measurement 216 can represent a sleeve length extending between the shoulder circumference and the end of the sleeve 108. A seventh measurement 218 can represent can represent a linear distance between an acromion and a bust of the user. An eighth measurement 220 can represent a linear distance between the neckline 110 and a bust of the user. A ninth measurement 222 can represent a linear distance across a chest of the user. A tenth measurement 224 can represent a circumferential distance around an upper chest of the user. An eleventh measurement 226 can represent a circumference distance around a bust of the user. A twelfth measurement 228 can represent a linear distance of a bust arc of the user. A thirteenth measurement 230 can represent a linear distance between a bust apex and under bust circumferential measurement. A fourteenth measurement 232 can represent a circumferential distance around and under bust area of the user. A fifteenth measurement 234 can represent a linear distance from the neckline 110 and the naval of the user. A sixteenth measurement 236 can represent a circumferential distance around the user from the naval. A seventeenth measurement 238 can represent a circumferential distance around hips of the user. A eighteenth measurement 240 can represent a linear distance between the naval and the bottom edge 112. A nineteenth measurement can represent a circumferential distance around the bottom edge 112.

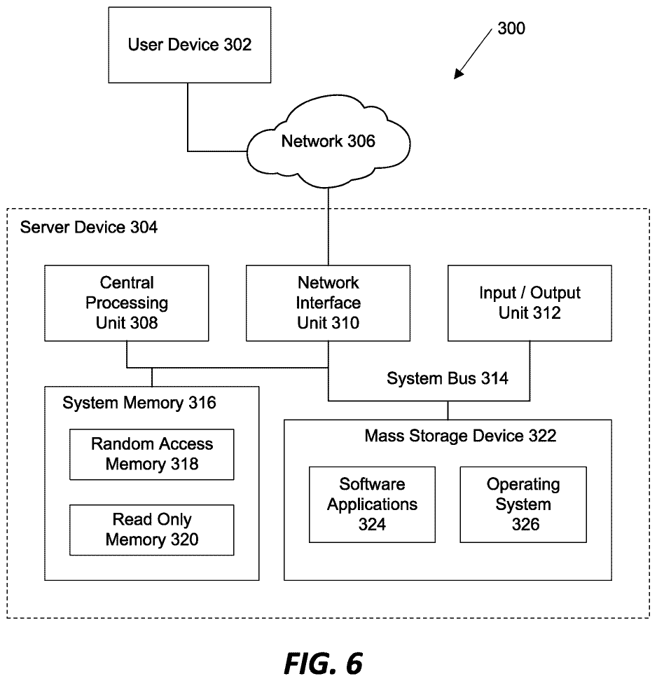

In embodiments, the bottom portion measurements 204 can be represented as a plurality of anatomical measurements between around certain features of the user. For example, a first measurement 244 can represent a circumferential distance around the waistline 114 of the user. A second measurement 246 can represent a circumferential distance around the user from the naval. A third measurement 248 can represent a circumferential distance around an upper portion of the hips of the user. A fourth measurement 250 can represent a circumferential distance around a lower portion of the hips of the user. A fifth measurement 252 can represent a crotch depth of the user. A sixth measurement 254 can represent a linear distance between the naval of a user and the waistline 114. A seventh measurement 256 can represent a linear distance between a crotch of the user and the waistline 114. An eighth measurement 258 can represent a circumferential distance around an upper thigh of the user. A ninth measurement 260 can represent a circumferential distance around a mid-thigh of the user. A tenth measurement 262 can represent a circumferential distance around a portion of the thigh above a knee of the user. An eleventh measurement 264 can represent a circumferential distance around a knee of the user. A twelfth measurement 266 can represent a circumferential distance around a portion of the calf below the knee of the user. A thirteenth measurement 268 can represent a circumferential distance around the widest part of the calf of the user. A fourteenth measurement 270 can represent a circumferential distance around a lower calf of the user. A fifteenth measurement 272 can represent a circumferential distance around an ankle of the user. A sixteenth measurement 274 can represent a linear inseam of the user. A seventeenth measurement 276 can represent a linear knee height of the user. An eighteenth measurement 278 can represent a linear belt seam to the ankle measurement. The above referenced measurements represent one embodiment of the disclosure, as a greater or fewer number of measurements of the user can be used to create the proprioception garment. In some embodiments, the user can be provided with a measurement system 300 (as depicted in FIG. 6) to aid in collection of the measurements. For example, in some embodiments, the system 300 can include one or more measurement devices, one or more tables to receive the data, as well as optional instructions for collecting the measurements. For example, in some embodiments, the system 300 can be provided through a mobile application in which a camera of a user device 302 (e.g., cellular telephone, etc.) is used to infer the measurements (e.g., employing measurement application technology), which can be autonomously recorded by a mobile application 324. Further, in some embodiments, the system 300 can be configured to display portions of video or other instruction to guide the user through the measurement process. Thereafter, the measurements can be input into an algorithm 330 to determine the dimensions of fabric panels to create the proprioception garment 100. As illustrated in FIG. 6, the measurement system 300 is structured within a computing environment that encompasses at least one user device 302 linked to a server 304 through a network 306. This network 306 serves as the foundational communication medium, facilitating the transfer and exchange of data between the user device(s) 302 and the server 304. Each user device 302 is defined as a computing device furnished with at least one processor and memory, showcasing adaptability. These user devices 302 can include a range of mobile computing devices, such as smartphones, tablets, laptops, and wearable devices.

Server 304 can embody a substantial computing infrastructure, akin to a server farm, and serves as the core entity within this environment. As illustrated in the embodiment of FIG. 6, the example server 304, which provides the functionality described herein, can include at least one central processing unit (“CPU”) 308, a system memory 316, and a system bus 314 that couples the system memory 316 to the CPU 308. The system memory 316 includes a random access memory (“RAM”) 318 and a read-only memory (“ROM”) 320. A basic input/output system containing the basic routines that help transfer information between elements within the financial analytics system 100, such as during startup, is stored in the ROM 320. The measurement system 300 further includes a mass storage device 322. The mass storage device 322 can store software instructions and data. A central processing unit, system memory, and mass storage device similar to that shown can also be included in the other computing devices disclosed herein. The mass storage device 322 is connected to the CPU 308 through a mass storage controller (not shown) connected to the system bus 314. The mass storage device 322 and its associated computer-readable data storage media provide non-volatile, non-transitory storage for the measurement system 300. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 304.

According to various embodiments of the invention, the measurement system 300 may operate in a networked environment using logical connections to remote network devices through network 306, such as a wireless network, the Internet, or another type of network. The network 306 provides a wired and/or wireless connection. In some examples, the network 306 can be a local area network, a wide area network, the Internet, or a mixture thereof. Many different communication protocols can be used.

The server device 304 may connect to network 306 through a network interface unit 310 connected to the system bus 314. It should be appreciated that the network interface unit 310 may also be utilized to connect to other types of networks and remote computing systems. The server device 304 also includes an input/output controller 312 for receiving and processing input from a number of other devices, including a touch user interface display screen or another type of input device. Similarly, the input/output controller 312 may provide output to a touch user interface display screen or other output devices.

As mentioned briefly above, the mass storage device 322 and the RAM 318 of the server device 304 can store software instructions and data. The software instructions include an operating system 326 suitable for controlling the operation of the server device 304. The mass storage device 322 and/or the RAM 318 also store software instructions and applications 324, that when executed by the CPU 308, cause the server device 304 to provide the functionality of the measurement system 300 discussed in this document. In embodiments, the measurement system 300 can employ machine learning to aid in identification of the patterns and sizes of the fabric panels used to create the proprioception garment 100. In some embodiments, the output of the measurement system 300 can be in terms of dimensional measurements of the fabric panels. In other embodiments, the output can be in the form of an image, wherein the image indicates the shape and size of the fabric panels used to create the proprioception garment 100, wherein each of the panels are specifically shaped and sized to produce the desired amount or degree of compression for improved proprioception in the user.

Neural networks typically consist of multiple layers, and the signal path traverses from front to back. The multiple layers perform a number of algorithms or transformations. In general, the number of layers is not significant and is use case dependent. For practical purposes, a suitable range of layers is from two layers to a few tens of layers. Modern neural network projects typically work with a few thousand to a few million neural units and millions of connections. The goal of the neural network is to solve problems in the same way that the human brain would, although several neural networks are much more abstract. The neural networks may have any suitable architecture and/or configuration known in the art.

The neural networks described herein belong to a class of computing commonly referred to as machine learning. Machine learning can be generally defined as a type of artificial intelligence (AI) that provides computers with the ability to learn without being explicitly programmed. Machine learning focuses on the development of computer programs that can teach themselves to grow and change when exposed to new data. In other words, machine learning can be defined as the subfield of computer science that “gives computers the ability to learn without being explicitly programmed.” Machine learning explores the study and construction of algorithms that can learn from and make predictions on data-such algorithms overcome following strictly static program instructions by making data driven predictions or decisions, through building a model from sample inputs.

The neural networks described herein may also or alternatively belong to a class of computing commonly referred to as deep learning (DL). Generally speaking, “DL” (also known as deep structured learning, hierarchical learning or deep machine learning) is a branch of machine learning based on a set of algorithms that attempt to model high level abstractions in data. In a simple case, there may be two sets of neurons: ones that receive an input signal and ones that send an output signal. When the input layer receives an input, it passes on a modified version of the input to the next layer. In a base model, there are many layers between the input and output layers, allowing the algorithm to use multiple processing layers, composed of multiple linear and non-linear transformations.

DL is part of a broader family of machine learning methods based on learning representations of data. An observation (e.g., an image) can be represented in many ways such as a vector of intensity values per pixel, or in a more abstract way as a set of edges, regions of particular shape, etc. Some representations are better than others at simplifying the learning task (e.g., pattern recognition and sizing in garment production). One of the promises of DL is replacing handcrafted features with efficient algorithms for unsupervised or semi-supervised feature learning and hierarchical feature extraction. Research in this area attempts to make better representations and create models to learn these representations from large-scale unlabeled data. Some of the representations are inspired by advances in neuroscience and are loosely based on interpretation of information processing and communication patterns in a nervous system, such as neural coding which attempts to define a relationship between various stimuli and associated neuronal responses in the brain.

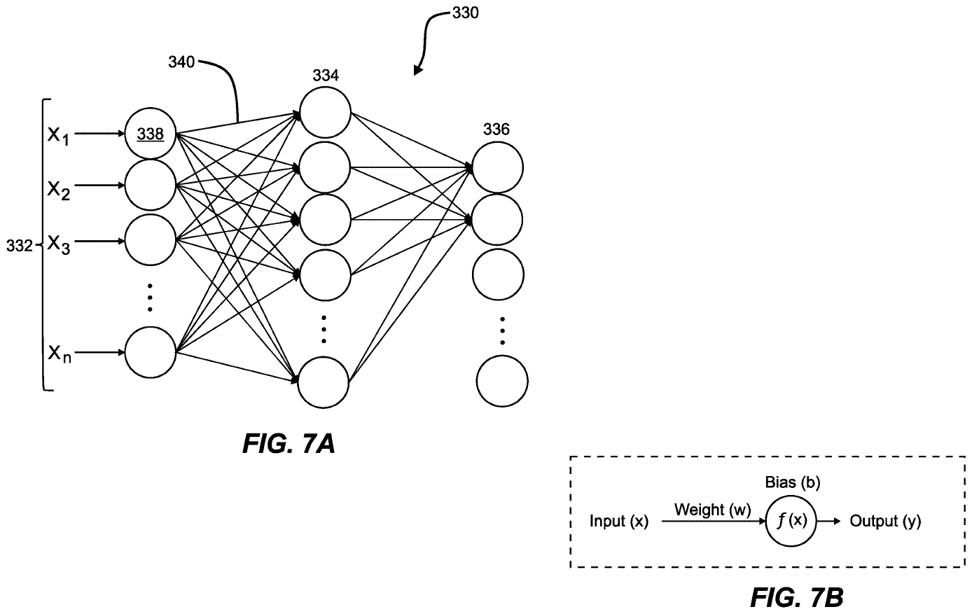

With additional reference to FIGS. 7A and 7B, at a basic level, the algorithm 330 (e.g., in the form of a neural network) can include an input layer 332, one or more hidden layers 334, and an output layer 336. Each of the layers 332, 334, and 308 can include a corresponding plurality of neurons 338. Although only a single hidden layer 334 is depicted, it is contemplated that the neural network 330 can include as few as one hidden layer or as many hidden layers as desired.

The inputs for the input layer can be any number along a continuous range (e.g., any number between 0 and 1, etc.). For example, in one embodiment, the input layer 332 can include a series of numbers representing the collection of top portion measurements 202 and bottom portion measurements 204, although other inputs to the input layer 332 are also contemplated. Each of the neurons 338 in a given layer (e.g., input layer 332) can be connected to each of the neurons 338 of the subsequent layer (e.g., hidden layer 334) via a connection 340, as such, the layers of the network can be said to be fully connected. With additional reference to FIG. 7B, each of the neurons 338 can be configured to receive one or more input values (x) and compute an output value (y). In fully connected networks, each of the neurons 338 can be assigned a bias value (b), and each of the connections 340 can be assigned a weight value (w). Collectively the weights and biases can be tuned as the neural network 330 learns how to correctly classify detected objects. Each of the neurons 338 can be configured as a mathematical function, such that an output of each neuron 338 is a function of the connection weights of the collective input, and the bias of the neuron 338, according to the following relationship:

$$y ≡ w \cdot x + b$$

In some embodiments, output (y) of the neuron 338 can be configured to take on any numerical value (e.g., a value of between 0 and 1, etc.). Further, in some embodiments the output of the neuron 338 can be computed according to one of a linear function, sigmoid function, tanh function, rectified linear unit, or other function configured to generally inhibit saturation (e.g., avoid extreme output values which tend to create instability in the neural network 330).

In some embodiments, the output layer 336 can include neurons 338 corresponding to a desired number of outputs of the neural network 330. For example, in one embodiment, the neural network 330 can include a plurality of output neurons providing dimensions for a plurality of fabric panels, which can be stitched together to form the proprioception garment 100.

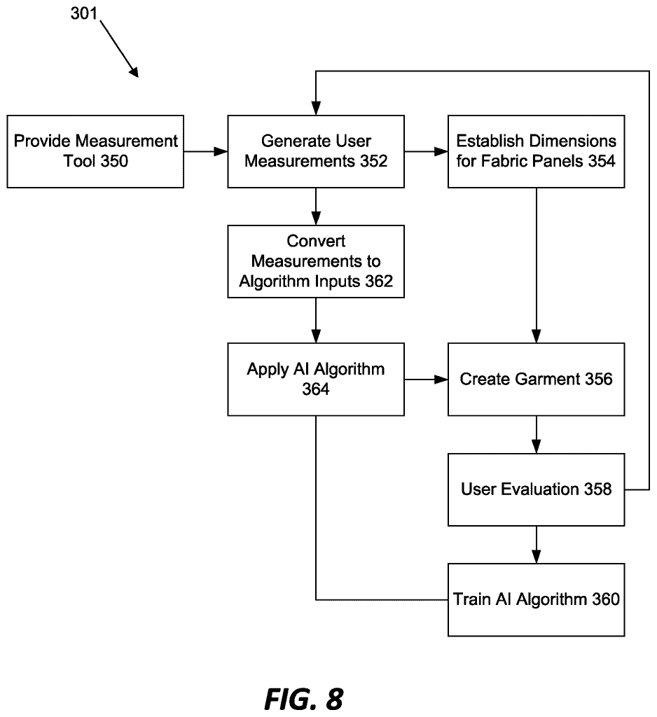

With additional reference to FIG. 8, a flowchart depicting a method 301 of training and/or using a neural network 330 for in the creation of a uniquely tailored proprioception garment 100 is depicted in accordance with an embodiment of the disclosure. At step 350, a measurement tool can be provided as an aid to users in collecting the various measurements for uniquely tailoring the fit of the proprioception garment 100 to their body. For example, in one embodiment, the measurement tool can be provided as part of a user interface presented on a display of user device 302. At step 352, the measurement tool can be used to gather measurement data, including the top portion measurements 202 and the bottom portion measurements 204. In some embodiments, the user measurements may be generated through transformation or put the performance of other mathematical functions to the measurements provided by the system 300.

At step 354, the measurements collected or generated at step 352 can be used to establish the shapes and sizes of a plurality of fabric panels for the construction of the proprioception garment 100 through conventional techniques (e.g., one or more known tailor artisan techniques). Thereafter, at step 356, the fabric panels can be stitched together to create the proprioception garment 100, which can then be worn by the user to provide feedback for refinement of the dimensions of the fabric panels. For example, at step 358, the user can provide guidance regarding the fit of the garment 100 (e.g., via an online survey, etc.). Depending upon the fit of the proprioception garment, the shapes and sizes of the fabric panels can be readjusted at step 352 to generate revised user measurements at step 354. In some embodiments, the readjustment can be automated, or at least partially automated by the system 300, based on the feedback provided through the user evaluation 358.

The fitting process (e.g., steps 352-358) can be completed numerous times for numerous users to establish a set of training data, which can be used to train the neural network 330, at step 360. The goal of the deep learning algorithm is to tune the weights and balances of the neural network 330 until the inputs to the input layer 332 are properly mapped to the desired outputs of the output layer 336, thereby enabling the algorithm to accurately produce outputs (y) for previously unknown inputs (x). For example, if the measurement tool captures a series of user measurements (the values of which are fed into the input layer 332), a desired output of the neural network 330 can be the shapes and sizes of the fabric panels used to create a proprioception garment 100. In some embodiments, the neural network 330 can rely on training data (e.g., inputs with known outputs) to properly tune the weights and balances.

In tuning the neural network 330, a cost function (e.g., a quadratic cost function, cross entropy cross function, etc.) can be used to establish how close the actual output data of the output layer 336 corresponds to the known outputs of the training data. Each time the neural network 330 runs through a full training data set can be referred to as one epoch. Progressively, over the course of several epochs, the weights and balances of the neural network 330 can be tuned to iteratively minimize the cost function.

Effective tuning of the neural network 330 can be established by computing a gradient descent of the cost function, with the goal of locating a global minimum in the cost function. In some embodiments, a backpropagation algorithm can be used to compute the gradient descent of the cost function. In particular, the backpropagation algorithm computes the partial derivative of the cost function with respect to any weight (w) or bias (b) in the neural network 330. As a result, the backpropagation algorithm serves as a way of keeping track of small perturbations to the weights and biases as they propagate through the network, reach the output, and affect the cost. In some embodiments, changes to the weights and balances can be limited to a learning rate to inhibit overfitting of the neural network 330 (e.g., making changes to the respective weights and biases so large that the cost function overshoots the global minimum). Additionally, in some embodiments, various methods of regularization, such as L1 and L2 regularization, can be employed as an aid in minimizing the cost function.

As the neural network 330 is tuned to correspond to the training data, the weights and biases of the neural network are gradually tuned to account for all of the dimensional data collected during the training phase, including determining ideal dimensions of fabric panels based on feedback from users in the training group.

With continued reference to FIG. 8, with the neural network 330 tuned, at steps 350-352, the measurement tool can be used to gather and generate measurement data, including the top portion measurements 202 and the bottom portion measurements 204. At step 362, the top portion measurements 202 and bottom portion measurements 204 can optionally be converted into input data for the input layer of the neural network 330. Thereafter, at step 364, the neural network 330 can be applied on the input data, with the goal of outputting dimensional information (e.g., shape, size, etc.) for the fabric panels, which can be stitched together to create the garment at step 356.

In some embodiments, the user evaluation step 358 can be used to further refine the fit of the proprioception garment 100. For example, in some embodiments, a user can be presented a survey to rate the overall fit of the garment. At step 352, the system 300 can generate revised user measurements, which can be converted to algorithm inputs at step 362. At step 364, the AI algorithm can be applied to establish garment measurements. At step 356, a second, improved version of the proprioception garment 100 can be created, which can be evaluated at step 358. In some embodiments, a user can further refine and/or customize a user specific AI algorithm to produce a proprioception garment 100 with desired fitness and wearability characteristics.

Accordingly, user feedback plays an important role in both the general training of the neural network 330 and its specific adaptation to individual users within the context of creating a uniquely tailored proprioception garment 100, enabling continuous refinement and personalization of the garment to meet specific needs. In the broader scope of training the neural network 330, the accumulation of user feedback across numerous fitting sessions forms a rich dataset of training data. Each iteration, from initial measurement collection to the provision of feedback on the garment's fit, contributes valuable insights into how different body measurements correlate with the optimal shapes and sizes of the fabric panels needed for the proprioception garment 100. This feedback is analyzed and used to adjust the neural network's parameters, specifically the weights and biases associated with each neuron. Over time, through the application of deep learning techniques, the neural network learns to more accurately predict the dimensions of the fabric panels required to achieve a desired fit for a broad range of body types. This generalized learning enhances the system's ability to tailor garments to new users with greater precision.

On a more individualized level, the neural network's utility extends to refining the fit of the proprioception garment for specific users through a series of targeted surveys. Each survey serves as a feedback loop, where users can comment on various aspects of the garment's fit, such as tightness, comfort, and mobility. This feedback can be inputted into the neural network, allowing for the adjustment of the garment's dimensions in subsequent iterations. For a single user, this process may involve several cycles of wearing the garment, providing feedback, and receiving an updated garment. With each cycle, the neural network can fine-tune its predictions for that particular user's optimal garment dimensions. This personalized approach ensures that the final proprioception garment not only adheres to the general principles of proprioceptive feedback but is also custom-fitted to the user's unique body shape and preferences, enhancing the garment's effectiveness and wearability.

Moreover, this iterative process, enriched by direct user feedback, enables the neural network to learn from the nuances of individual preferences and body shapes, by adjusting its internal model to account for factors that may not be immediately evident from initial measurements alone. This capability ensures that the system becomes more adept over time at anticipating user needs, leading to a more intuitive and user-centric approach to garment design.

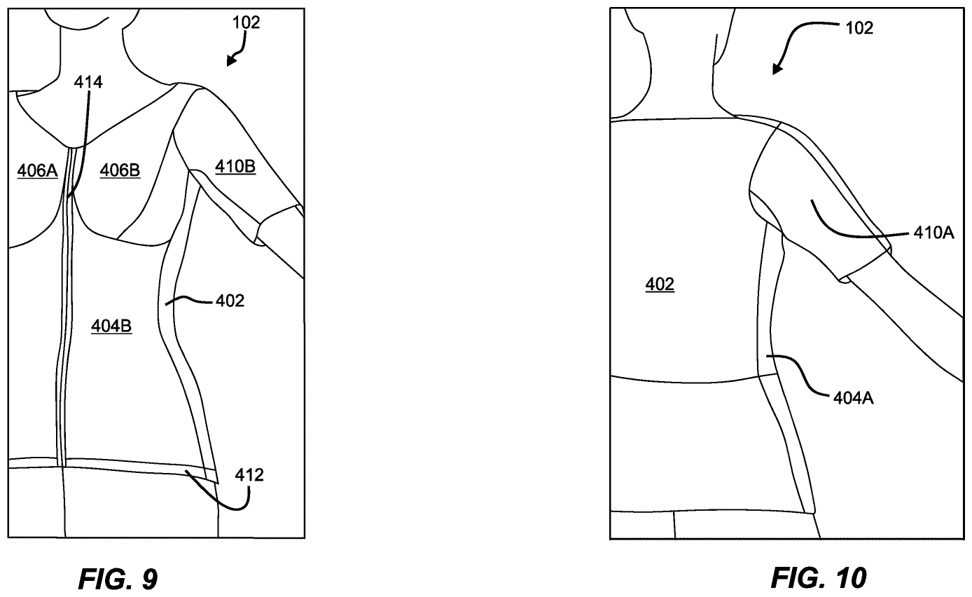

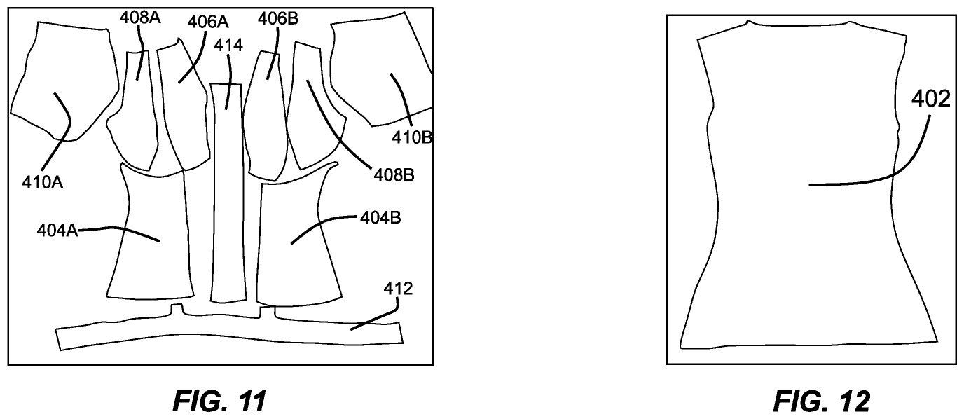

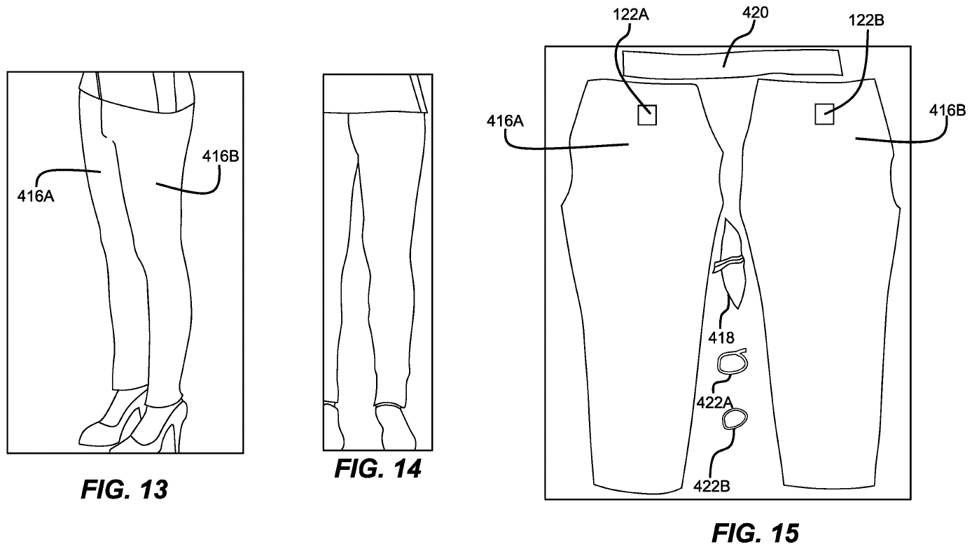

Furthermore, the system 300 can empower users by offering them a selection of predefined garment adjustments post-feedback, for example, via an interactive element to the fitting process, where users can actively participate in the customization of their garment. In embodiments, each predefined adjustment option can be mapped to specific changes in the AI algorithm's parameters, particularly the bias and weight values of the neural network. When a user selects an adjustment, the system can recalibrates these values to reflect the chosen modification. This could range from altering the tightness around specific areas, such as the waist or arms, to adjusting the overall length of the garment. As a result, users can see immediate virtual updates to the garment's fit based on their selections, providing a highly personalized and engaging fitting experience. This level of customization not only ensures that the final garment meets the user's exact preferences but also fosters a deeper connection between the user and the design process. With additional reference to FIGS. 9-12, a series of fabric panels comprising the top portion 102 are depicted in accordance with an embodiment of the disclosure. In some embodiments, the top portion 102 can include a back panel 402, a pair of abdominal panels 404A-B (e.g., a right side abdominal panel 404A and a left side abdominal panel 404B), a pair of upper chest panels 406A-B (e.g., a right side upper chest panel 406A and a left side upper chest panel 406B), a pair of lower chest panels 408A-B (e.g., a right side lower chest panel 408A and a left side lower chest panel 408B), a pair of arm panels 410A-B (e.g., a right side arm panel 410A and a left side arm panel 410B, a bottom edge band panel 412, and a zipper assembly 414. As depicted, the back panel 402, abdominal panels 404, chest panels 406/408, arm panels 410, bottom edge band panel 412, and zipper assembly 414 can be stitched together to create a complete top portion 102. With additional reference to FIGS. 13-15, a series of fabric panels comprising the bottom portion 104 are depicted in accordance with an embodiment of the disclosure. In some embodiments, the bottom portion 104 can include a pair of leg panels 416A-B (e.g., a right leg panel 416A and a left leg panel 416B), a crotch panel 418, a waistband panel 420, and a pair of ankle cuff assemblies 422A-B (e.g., a right ankle cuff assembly 422A and a left ankle cuff assembly 422B). As depicted, the leg panels 416, crotch panel 418, waistband panel 420, and ankle cuff assemblies 422 can be stitched together to create a complete bottom portion 104.

As previously described, the specific dimensions of the back panel 402, abdominal panels 404, chest panels 406/408, arm panels 410, bottom edge band panel 412, and zipper assembly 414, leg panels 416, crotch panel 418, waistband panel 420, and ankle cuff assemblies 422 can be determined by the neural network algorithm 330. In some embodiments, certain fabric panels can be omitted based on the dimensional characteristics of the user. For example, where female users with larger chests may require lower chest panels 408A/B for a proper fit, a these panels may be omitted in the top portion 102 for a male user. Other modifications to the shapes, sizes and presence of the panels are also contemplated. Accordingly, the proprioception garment 100 can be specifically tailored to male, female and adolescent body types through the modification and/or omittance of the plurality of fabric panels.

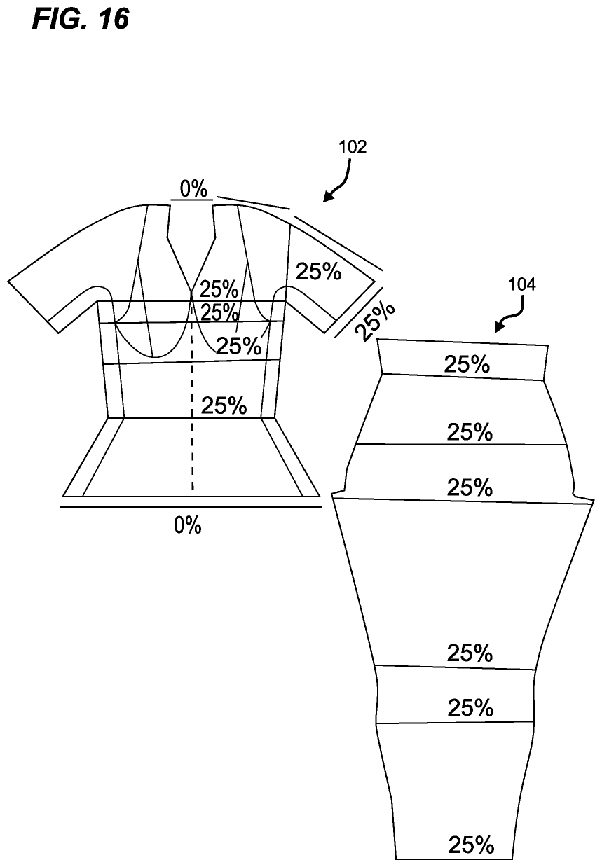

With additional reference to FIG. 16, the plurality of fabric panels can be constructed of a variety of fabric materials having certain elastic properties. For example, in one embodiment, the plurality of fabric panels can be constructed from a fabric made from a mix of 75% nylon and 25% spandex; although the use of other types of fabric are also contemplated. In embodiments, the fabric can be hypoallergenic and/or temperature regulating.

In some embodiments, the fabric can have elastic properties enabling the fabric to stretch, thereby imparting an equal and opposite reaction force in the form of compression on the skin of the user. In general terms, the amount of compression (e.g., compression load) imparted to a user by the proprioception garment 100 can be represented as a percentage, wherein the percentage indicates the amount of stretch in the fabric under normal conditions. For example, un-stretched fabric (e.g., fabric under no load) is indicated by 0% stretch, whereas fabric stretched at its maximum (e.g., further stretching may cause the fabric to tear) is indicated by 100% stretch. As depicted in FIG. 16, in some embodiments, both the top portion 102 and bottom portion 104 can be configured to impart a 25% compression load on the user (e.g., the fabric comprising the plurality of panels is stretched approximately 25% when worn by a user).

In other embodiments, the compression applied to the user can be varied among the plurality of panels. For example, in some embodiments, a 25% compression load can be applied across the bust arc, bust back, lower hips and thighs of the user, a 30% compression load can be applied around the biceps of the user, a 40% compression load can be applied around the knees and ankles of a user, and a 42% compression load can be applied around the waist of the user. In other embodiments, the compression loads can range between about 5% and about 50% across the various regions and features of a user. In some embodiments, desired degree of fabric stretch can equate to a compression load in a range of between about 6 mmHg and about 15 mmHg (gauge pressure), as applied to a user wearing the proprioception garment 100. As used herein, the term “about” means ±five percent. Accordingly, in embodiments, the top portion 102 and the bottom portion 104 can represent level I compression garments appropriate for proprioception therapy.

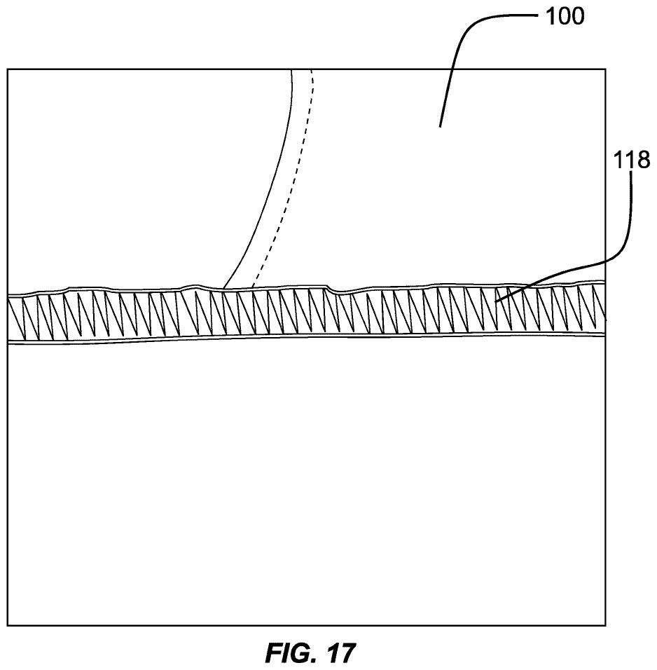

With additional reference to FIG. 17, in embodiments, the various fabric panels can be stitched together with a thread having elastic qualities, such that the threat does not unintentionally impart additional compression to the user during normal wear. For example, in some embodiments, the various fabric panels can be stitched together along a seam 118 with an elastic thread through a triple stitching technique, in which an overlapping of the panels along the seam 118 is positioned on an exterior of the garment, so as to create a smooth inner surface of the proprioception garment 100 to inhibit inadvertent application of increased compression along the seam 118.

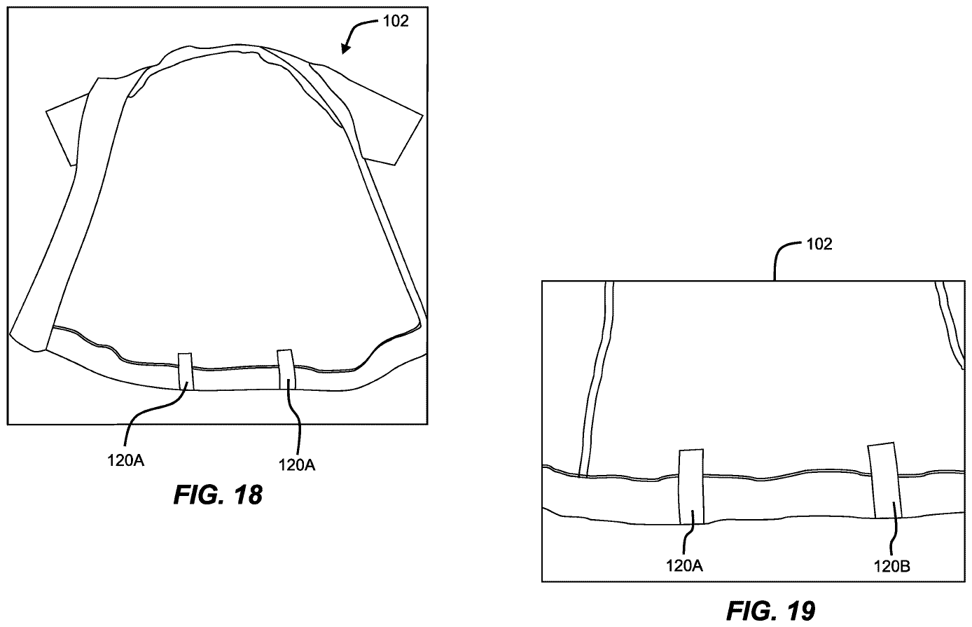

As depicted in FIGS. 18-19, in some embodiments, the top portion 102 can include one or more tabs 120A/B configured to be selectively couplable to corresponding tabs 122A/B positioned on the bottom portion 104 (as depicted in FIG. 15), thereby selectively coupling the top portion 102 to the bottom portion 104. For example, in some embodiments, the tabs 120/122 can be in the form of a hook and loop fastener arrangement. Accordingly, in some embodiments, tabs 120A/B (e.g. representing loops of the hook and loop fastener arrangement) can be positioned on an inner surface of the top portion 102, while tabs 122A/B (e.g., representing hooks of the hook and loop fastener arrangement) can be positioned on an outer surface of the bottom portion 104, such that when worn by the user, tabs 120A/B align with tabs 122A/B, thereby securing the top portion 102 to the bottom portion 104 to effectively create a unitary proprioception garment 100.

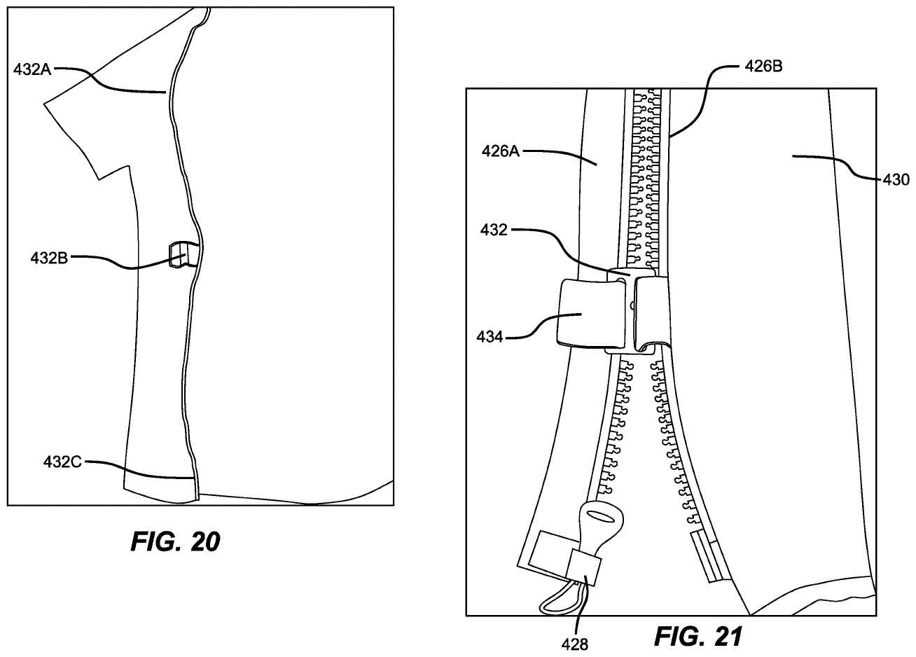

With additional reference to FIGS. 20-21, in some embodiments, the zipper assembly 414 can include first and second sides of a zipper tape 426A/B (e.g., including teeth, a bottom stop, etc.), a pull tab/slider 428, a fabric barrier layer 430, and one or more hooks 432, and corresponding loops 434. For example, in some embodiments, the top portion 102 can include three hooks 432A-C and three loops 434A-C; although other quantities of hooks and loops are also contemplated. In embodiments, the fabric barrier layer 430 can aid in protecting the skin of user from direct contact with the zipper tape 426A/B and pull tab/slider 428. In particular, the fabric barrier layer 430 can be configured to be positioned adjacent to the skin of the user beneath the zipper tape 426A/B and pull tab/slider 428.

The hooks 432 and loops 434 can be used as an aid in transitioning the zipper assembly 414 from the open (e.g., unzipped) position to the closed (e.g., fully zipped) position. Given the compression imparted by the fabric, user experience has shown that it can be difficult to transition the zipper assembly 414 from the open position to the closed position. To address this concern, in some embodiments, a user can first secure the hooks 432 to the loops 434, which can have the effect of positioning the first side of the zipper tape 426A in proximity to the second side of the zipper tape 426B, thereby significantly easing the transition of the zipper assembly to the closed position.

One problem with existing compression garments is that the wrist and ankle bands can be too tight at times. For example, if a patient experiences edema (e.g., swelling) in the feet, the compression load applied around the ankles of the user may need to be reduced to increase circulation and reduce the swelling. To address this concern, in some embodiments, the proprioception garment 100 can include an adjustable ankle cuff assembly 422.

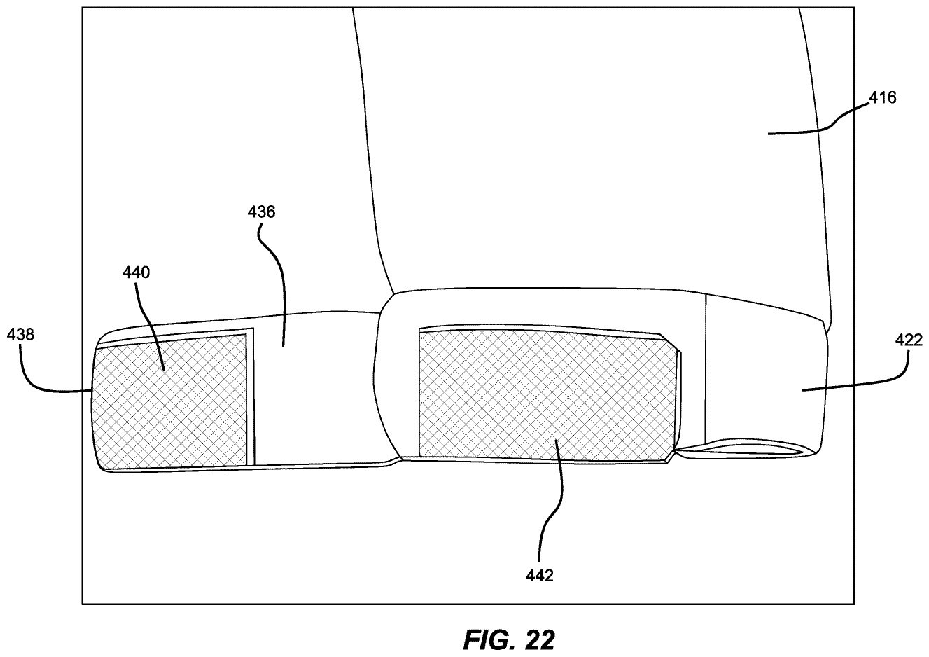

With reference to FIG. 22, an adjustable ankle cuff assembly 422 is depicted in accordance with an embodiment of the disclosure. As depicted, in some embodiments, the adjustable ankle cuff assembly 422 can include a tab 436 including one portion of a hook and loop fastener mechanism 440, with the other portion of the hook and loop mechanism 442 positioned around the ankle of the user at a bottom of the leg panel 416.

In embodiments, manipulation of the tab 436 including the hook and loop fastener mechanism 440/442 can enable the user to regulate the amount of compression provided by the ankle cuff assembly 422. During normal use, the compression provided by the ankle cuff assembly 422 can be regulated to approximately equal the compression provided by other portions of the bottom portion 104. At other times, and during donning and doffing of the bottom portion 104, the tab 436 can be manipulated (e.g., the portions of the hook and loop fastener mechanism 440/442 can be loosened or separated) to correspondingly adjust the compression applied by the ankle cuff assembly 422. Accordingly, in some embodiments, the ankle cuff assembly 422 can be configured to provide a consistent compression in the range of between about 6 mmHg and about 15 mmHg (e.g., when the terminal end 438 of the hook or loop fastener mechanism 440 overlaps with the ankle cuff assembly 422 to be positioned at point MAX). However, if the compression proves to be too much, the user can optionally reduce the compression in the ankle region by adjusting the position of the terminal end 438 of the hook or loop fastener mechanism 440. For example, the terminal and 438 of the hook or loop fastener mechanism 440 can be moved along the portion of the hook or loop fastener mechanism 442 from point MAX to anywhere from between point MAX and point MIN. Similar structures can be positioned along the waistline and wrists of the proprioception garment 100.

Thus, while traditional ankle, wrist and waistbands may include elastic or hook and loop fasteners to increase the pressure at the ankles, wrists and waist of a user in order to keep the garment securely in place, the present disclosure employs the tab 436 and hook and loop fastener mechanism 440/442 to reduce the compression, in some cases to a 0% fabric stretch/compression. Accordingly, in some embodiments, ankle cuff assembly 422 can be configured to enable regulation of the compression around the ankles of the user to inhibit the onset of an allergic reaction, swelling in the feet and other associated conditions or symptoms experienced by the user.

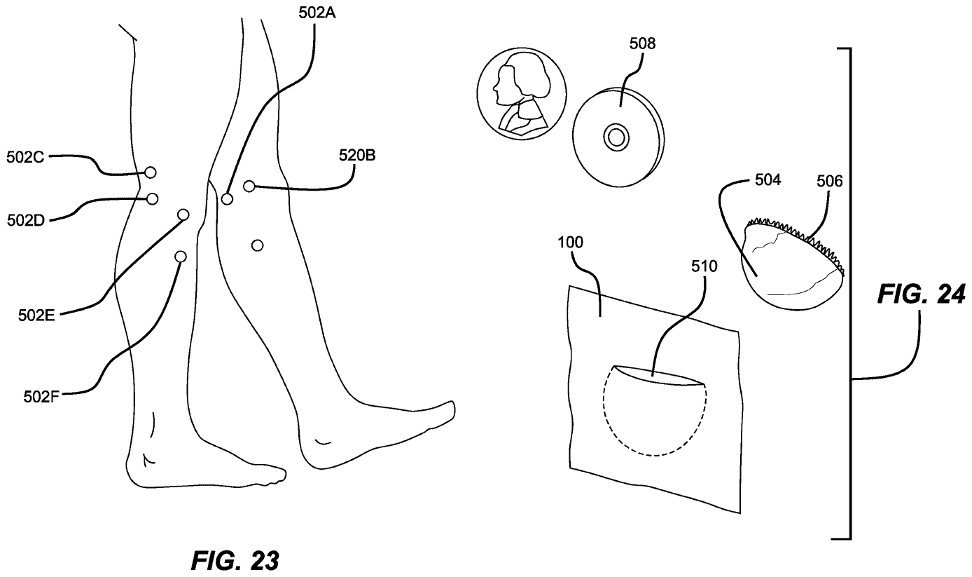

With additional reference to FIGS. 23-24, in some embodiments, the proprioception garment 100 can be configured to provide acupressure therapy through increased pressure at certain acupressure points 502A-F of a user. For example, as depicted in FIG. 23, various acupressure points 502A-F can be located around a knee of the user, although the specific locations of the acupressure points (which can be located on other parts or areas of the body of the user other than the knee) are unique to the anatomy of the user. In embodiments, the added pressure at the acupressure points can provide added stimulation to the body at that location, and can result in decreased pain as well as having the effect of causing certain parts of the body to relax. Other acupressure points are known to reduce or suppress pressure related allergic reactions.

As further depicted in FIG. 24, in some embodiments, the proprioception garment 100 can be stitched to provide a relatively uniform compression loading (e.g., according to the compression loads described above), while providing additional pressure or stimulation at certain acupressure points. To aid in providing additional pressure or stimulation at certain acupressure points, in some embodiments, an acupressure node 504, which in some embodiments can be in the form of a weighted bead, can be positioned on an interior surface of the proprioception garment 100. For example, in some embodiments, the acupressure node 504 can include a securement mechanism 506 (e.g., hook and loop fastener mechanism) or otherwise roughened surface configured to grip an interior surface of the proprioception garment 100 for the purpose of maintaining positional accuracy relative to the proprioception garment 100 for the application of acupressure therapy to a specific acupressure point.

In other embodiments, the acupressure node 504 can be replaced with an electronic acupressure stimulator 508, which can include a cathode and an anode configured to transmit a small amount of electricity to a skin of the user, thereby electronically triggering the acupressure points. In embodiments, the acupressure stimulator 508 can be positioned on an interior surface of the proprioception garment 100, so as to be positioned adjacent to the skin of the user. In other embodiments, a small pocket 510 can be formed in the proprioception garment to selectively hold either of the acupressure node 504 or acupressure stimulator 508 in a fixed position relative to the proprioception garment 100. In embodiments, the pocket 510 can be positioned on an exterior of the proprioception garment 100 to maintain a smooth interior surface. Accordingly, in some embodiments, the acupressure node 504 or acupressure stimulator 508 can be positioned within the proprioception garment 100 while wearing the garment.

In other embodiments, the specific acupressure points unique to the user can be collected by the measurement tool (as depicted in step 350 of FIG. 8), which can be designated on the surface of the proprioception garment 100 with a visual indicator (e.g., stitching, print marking, etc.). In some embodiments, the visual indicator, which can include stitching can have non-resilient/non-stretching qualities, which can have the effective increasing the compression load at the site of the acupressure point, thereby effectuating passive acupressure stimulation. Other combinations of the various acupressure features as discussed herein are also contemplated.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1-20. (canceled)

21. A proprioception garment configured to apply region-specific compression to a body of a user, the proprioception garment comprising:
(a) a top portion configured as a full zip shirt, the top portion comprising a plurality of elastic fabric panels dimensioned based on user-specific anatomical measurements and stitched together to impart a predetermined level of compression across upper body regions of the user, the top portion further including a zipper assembly positioned along a front of the top portion;
(b) a bottom portion configured as a pair of compression leggings, the bottom portion comprising a plurality of elastic fabric panels dimensioned based on user-specific anatomical measurements and stitched together to impart a predetermined level of compression across lower body regions of the user;
(c) wherein the top portion and the bottom portion are configured to apply region-specific compression loads ranging between about 6 mmHg and about 15 mmHg, the compression loads varying by anatomical region to enhance proprioceptive feedback;
(d) wherein the zipper assembly comprises:
(i) a first side and a second side of a zipper tape,
(ii) a pull tab and slider, and
(iii) a plurality of hooks and corresponding loops located on opposite sides of the zipper tape, the plurality of hooks and loops configured to be secured together by the user to draw a first and a second side of the zipper tape into alignment prior to actuation of the zipper assembly, thereby facilitating closure of the zipper assembly under tension caused by compression of the top portion; and
(e) an adjustable cuff assembly positioned at an ankle or wrist of the proprioception garment, the adjustable cuff assembly comprising a tab and a hook and loop fastener mechanism configured to enable the user to selectively reduce a cuff portion compression load of the proprioception garment.

22. The proprioception garment of claim 21, wherein the top portion comprises at least one of a back panel, an abdominal panel, a chest panel, an arm panel, or a bottom edge band panel, each stitched together with an elastic thread.

23. The proprioception garment of claim 21, wherein the bottom portion comprises at least one of a leg panel, a crotch panel, a waistband panel, or an ankle cuff assembly, each stitched together to form a conforming lower garment.

24. The proprioception garment of claim 21, wherein each of the plurality of elastic fabric panels comprise a material blend of approximately 75% nylon and 25% spandex.

25. The proprioception garment of claim 21, wherein the compression loads applied by at least one of the top portion or the bottom portion corresponds to a fabric stretch of approximately 25%.

26. The proprioception garment of claim 21, wherein the compression loads vary by region and includes at least a 30% compression load around biceps of the user, at least a 40% compression load around knees or ankles of the user, and at least a 42% compression load around a waist of the user.

27. The proprioception garment of claim 21, wherein the plurality of elastic fabric panels are dimensioned using at least ten user-specific anatomical measurements including linear distances and circumferential dimensions between or around anatomical landmarks of the user.

28. The proprioception garment of claim 21, wherein the top portion and the bottom portion are configured to selectively couple to one another using a tab-and-loop fastening arrangement to create a unitary garment.

29. The proprioception garment of claim 21, further comprising a fabric barrier layer positioned beneath the zipper tape and slider, the fabric barrier layer configured to reduce skin irritation and improve comfort during use.

30. The proprioception garment of claim 21, wherein the adjustable cuff assembly is configured to provide compression loads ranging between about 6 mmHg and about 15 mmHg when the hook and loop fastener mechanism is secured at a maximum compression position.

31. The proprioception garment of claim 21, wherein the adjustable cuff assembly is configured to allow the user to reduce the compression to substantially zero by repositioning the hook and loop fastener mechanism to a minimum compression position.

32. The proprioception garment of claim 21, further comprising one or more acupressure nodes secured to an interior surface of the proprioception garment and configured to apply localized pressure at one or more user-specific acupressure points.

33. The proprioception garment of claim 21, further comprising an electronic acupressure stimulator retained within a pocket of the proprioception garment and configured to deliver an electrical signal to a skin of the user at a designated acupressure point.

34. The proprioception garment of claim 21, further comprising a pocket positioned on an exterior surface of the proprioception garment, the pocket configured to hold an acupressure node or an acupressure stimulator in a fixed position relative to the proprioception garment.

35. The proprioception garment of claim 21, wherein at least one visual indicator is positioned on a surface of the proprioception garment to identify an acupressure point, the at least one visual indicator comprising non-stretch stitching to increase the compression load at the acupressure point.

36. A proprioception garment configured to apply region-specific compression and acupressure therapy to a body of a user, the proprioception garment comprising:
(a) a top portion configured as a full zip shirt, the top portion comprising a plurality of elastic fabric panels dimensioned based on user-specific anatomical measurements and stitched together to impart a predetermined level of compression across upper body regions of the user, the top portion further including a zipper assembly positioned along a front of the top portion;
(b) a bottom portion configured as a pair of compression leggings, the bottom portion comprising a plurality of elastic fabric panels dimensioned based on user-specific anatomical measurements and stitched together to impart a predetermined level of compression across lower body regions of the user;
(c) wherein the top portion and the bottom portion are configured to apply region-specific compression loads ranging between about 6 mmHg and about 15 mmHg, the compression varying by anatomical region to enhance proprioceptive feedback; and
(d) one or more acupressure nodes secured within respective pockets positioned on one of an interior surface or an exterior surface of the proprioception garment, each acupressure node configured to apply localized pressure at a respective acupressure point on the body of the user.

37. The proprioception garment of claim 36, wherein each of the one or more acupressure nodes comprises a weighted bead configured to exert downward pressure at a corresponding acupressure point.

38. The proprioception garment of claim 36, wherein each pocket comprises a hook and loop fastener configured to secure the acupressure node in a fixed position relative to the proprioception garment.

39. The proprioception garment of claim 36, wherein the pockets are removably closable to allow selective insertion and removal of the one or more acupressure nodes.

40. The proprioception garment of claim 36, wherein the one or more acupressure nodes are positioned at user-specific anatomical locations determined based on a measurement protocol performed prior to garment fabrication.

41. The proprioception garment of claim 36, wherein the top portion and the bottom portion are stitched with an elastic thread using a triple-stitch seam to maintain fabric elasticity and minimize pressure discontinuities at seam locations.
